(19) United States
(12) Patent Application Publication
(10) Pub. No.: US 2021/0030072 A1
(43) Pub. Date: Feb. 4, 2021

(54) VAPORIZATION DEVICE

(71) Applicant: SHENZHEN RELX TECHNOLOGY CO., LTD., Shenzhen City (CN)

(72) Inventors: Yao FU, Shenzhen City (CN); Zugang YANG, Shenzhen City (CN); Shuting FENG, Shenzhen City (CN); Jin ZHANG, Shenzhen City (CN)

(21) Appl. No.: 16/579,886

(22) Filed: Sep. 24, 2019

(30) Foreign Application Priority Data
Jul. 30, 2019 (CN) 201910697664.0

(51) Int. Cl. A24F 47/00; H05B 3/06; H05B 3/42

(52) U.S. Cl. CPC A24F 47/008; H05B 3/42; H05B 3/06

(57) ABSTRACT

The present application relates to a vaporization device. The vaporization device includes a housing, a heating component cap having a first surface and a second surface, and a first sealing member disposed on the heating component cap. The first surface has an edge, a length extending along a first axis, and a width extending along a second axis. The heating component cap includes a first groove, and the first groove and the first sealing member define a first channel. The first sealing member covers the first groove on the first surface, and exposes the first groove on the second surface.

### CROSS REFERENCE TO RELATED APPLICATIONS

The present application claims the benefit of priority from the China Patent Application No. 201910697664.0, filed on 30 Jul. 2019, the disclosure of which is hereby incorporated by reference in its entirety.

### BACKGROUND

### 1. Technical Field

The present application generally relates to a vaporization device, and more particularly to an electronic device for providing an inhalable aerosol.

### 2. Description of the Related Art

An electronic cigarette is an electronic product that heats and vaporizes a vaporizable solution to produce an aerosol for a user to inhale. In recent years, major manufacturers begin to produce various electronic cigarette products. Existing electronic cigarette products have different defects, which may be generated by improper design of relative positions between different members. For example, in a common electronic cigarette product, a heating component, an airflow channel, and an air outlet are designed to be aligned with each other in a vertical direction. Because the airflow channel has a certain length, the aerosol passing through the airflow channel may be cooled to form a condensate attached to the wall of the airflow channel. For this design, when the residual condensate reaches a particular volume, the condensate easily falls down from the airflow channel to contact with the heating component. The fallen condensate may contaminate the heating component and change the flavor of the aerosol. In addition, when the condensate directly falls onto the heating component with high temperature, the liquid may be splashed, and the splashed liquid may even burn the user.

Therefore, a vaporization device which can resolve the above problem is provided.

### SUMMARY

A vaporization device is provided. The vaporization device includes a housing, a heating component cap having a first surface and a second surface, and a first sealing member disposed on the heating component cap. The first surface has an edge, a length extending along a first axis, and a width extending along a second axis. The heating component cap includes a first groove, and the first groove and the first sealing member define a first channel. The first sealing member covers the first groove on the first surface, and exposes the first groove on the second surface.

A vaporization device is provided. The vaporization device includes a housing, a heating component cap, a heating component base, a first sealing member disposed on the heating component cap, and a heating component disposed between the heating component cap and the heating component base. The heating component and the heating component base define an atomization chamber. The heating component cap includes a first opening on a first surface and a first groove at an edge, and the first sealing member covers the first opening and exposes the first opening.

### BRIEF DESCRIPTION OF THE DRAWINGS

The aspects of the present invention will become more comprehensible from the following detailed description made with reference to the accompanying drawings. It should be noted that, various features may not be drawn to scale, and the sizes of the various features may be increased or reduced arbitrarily for the purpose of clear description.

FIG. 1 is a schematic assembled view of a vaporization device according to some embodiments of the present disclosure.

FIG. 2A and FIG. 2B are exploded views of portion of a vaporization device according to some embodiments of the present disclosure.

FIG. 3A, FIG. 3B, FIG. 3C, FIG. 3D, FIG. 3E, FIG. 3F and FIG. 3G are three-dimensional views of a heating component cap according to some embodiments of the present disclosure.

FIG. 4A and FIG. 4B are cross-sectional views of a cartridge according to some embodiments of the present disclosure.

FIG. 5 is a bottom view of portion of a cartridge according to some embodiments of the present disclosure.

The drawings and detailed descriptions use the same reference numerals to indicate same or similar elements. The present invention will be more apparent from the detailed descriptions made with reference to the accompanying drawings.

### DETAILED DESCRIPTION

The following disclosed content provides many different embodiments or examples of different features used to implement the provided subject matters. The following describes particular examples of components and deployments. Certainly, these are merely examples and are not intended to be limitative. In the present invention, in the following descriptions, reference formed by the first feature above or on the second feature may include an embodiment formed by direct contact between the first feature and the second feature, and may further include an embodiment in which an additional feature may be formed between the first feature and the second feature to enable the first feature and the second feature to be not in direct contact. In addition, in the present invention, reference numerals and/or letters may be repeated in examples. This repetition is for the purpose of simplification and clarity, and does not indicate a relationship between the described various embodiments and/or configurations.

The embodiments of the present invention are described in detail below. However, it should be understood that, the present invention provides many applicable concepts that can be implemented in various particular cases. The described particular embodiments are only illustrative and do not limit the scope of the present invention.

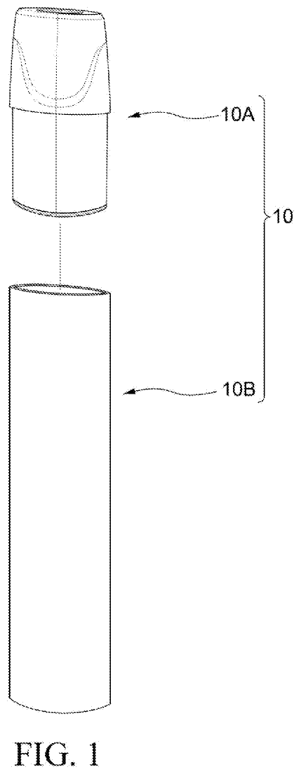

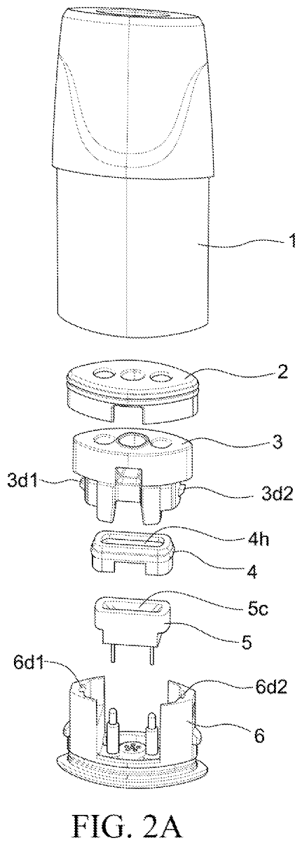

FIG. 1 is a schematic assembled view of a vaporization device according to some embodiments of the present disclosure.

The vaporization device 10 may include a cartridge 10A and a body 10B. In some embodiments, the cartridge 10A and the body 10B may be designed as an integral device. In some embodiments, the cartridge 10A and the body 10B may be designed as two separate components. In some embodiments, the cartridge 10A may be designed to be removably combined with the body 10B. In some embodiments, the cartridge 10A may be designed to be partially received in the body 10B.

The body 10B may include many components therein. Although not shown in FIG. 1, the body 10B may include a conductive elastic pin, a sensor, a circuit board, a light guiding assembly, a buffer assembly, a power supply assembly (for example, but not limited to, a battery or a rechargeable battery), a power supply assembly bracket, a motor, a charging board, and other components required for operation of the vaporization device 10. The body 10B may provide a power supply to the cartridge 10A. The power supply provided by the body 10B to the cartridge 10A can heat a vaporizable material stored in the cartridge 10A. The vaporizable material may be a liquid. The vaporizable material may be a solution. In subsequent paragraphs of the present disclosure, the vaporizable material may also be referred to as an e-liquid. The e-liquid is edible.

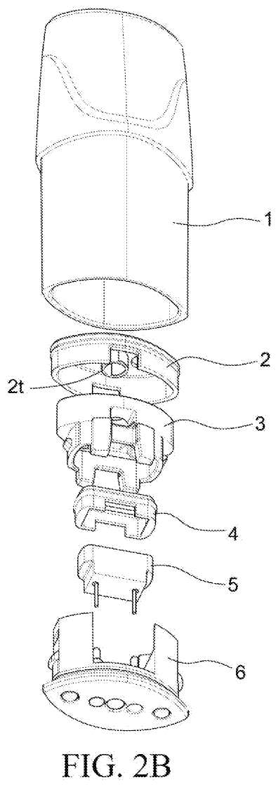

FIG. 2A and FIG. 2B are exploded views of a cartridge according to some embodiments of the present disclosure.

The cartridge 10A includes a housing 1, a cap sealing member 2, a heating component cap 3, a heating component sealing member 4, a heating component 5, and a heating component base 6. The heating component 5 may have a heating circuit (not shown) on a surface thereof. The heating component 5 may have a heating circuit (not shown) therein.

As shown in FIG. 2A, the cap sealing member 2 may have a plurality of openings. The heating component cap 3 may have a plurality of openings. In some embodiments, the number of openings of the cap sealing member 2 and the number of openings of the heating component cap 3 may be the same. In some embodiments, the number of openings of the cap sealing member 2 and the number of openings of the heating component cap 3 may be different. In some embodiments, the number of openings of the cap sealing member 2 is less than the number of openings of the heating component cap 3. In some embodiments, the number of openings of the cap sealing member 2 is greater than the number of openings of the heating component cap 3.

In some embodiments, the cap sealing member 2 may be elastic. In some embodiments, the cap sealing member 2 may be flexible. In some embodiments, the cap sealing member 2 may include silica gel. In some embodiments, the cap sealing member 2 may be made of silica gel.

The heating component cap 3 may have fastening portions 3d1 and 3d2. The heating component base 6 may have fastening portions 6d1 and 6d2. The heating component cap 3 may be coupled to the heating component base 6 through the fastening portions 3d1, 3d2, 6d1 and 6d2. The heating component cap 3 may be mechanically combined with the heating component base 6 through the fastening portions 3d1, 3d2, 6d1 and 6d2. The heating component cap 3 may be removably combined with the heating component base 6 through the fastening portions 3d1, 3d2, 6d1 and 6d2.

When some or all of the components of the cartridge 10A are combined with each other, the cap sealing member 2 may cover a portion of the heating component cap 3. The cap sealing member 2 may surround a portion of the heating component cap 3. The cap sealing member 2 may expose a portion of the heating component cap 3.

When some or all of the components of the cartridge 10A are combined with each other, the heating component sealing member 4 may cover a portion of the heating component 5. The heating component sealing member 4 may surround a portion of the heating component 5. The heating component sealing member 4 may expose a portion of the heating component 5.

In some embodiments, the heating component sealing member 4 may be elastic. In some embodiments, the heating component sealing member 4 may be flexible. In some embodiments, the heating component sealing member 4 may include silica gel. In some embodiments, the heating component sealing member may be made of silica gel.

As shown in FIG. 2A, the heating component sealing member 4 has an opening 4h, and the heating component 5 has a groove 5c. When the heating component sealing member 4 and the heating component 5 are combined with each other, the opening 4h may expose at least a portion of the groove 5c.

As is shown in FIG. 2B, the cap sealing member 2 may have an extending portion 2t. When the cap sealing member 2 and the heating component cap 3 are combined with each other, the extending portion 2t extends into a channel of the heating component cap 3.

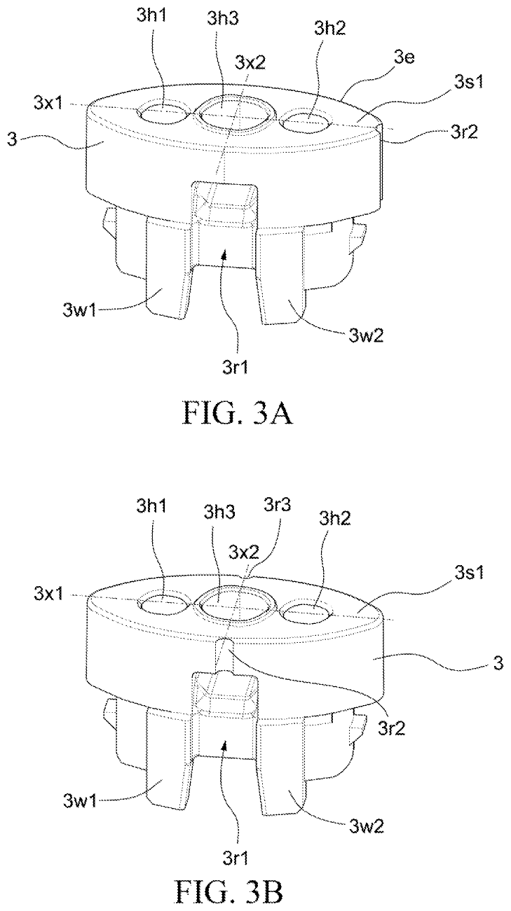

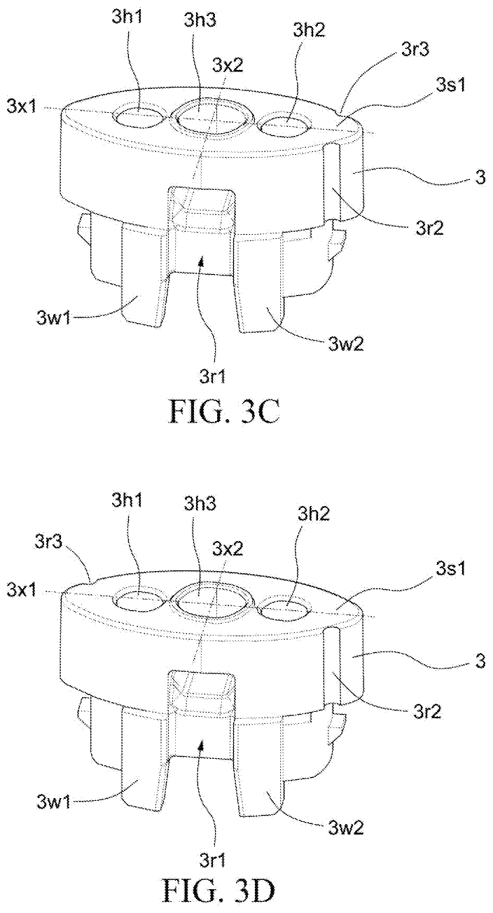

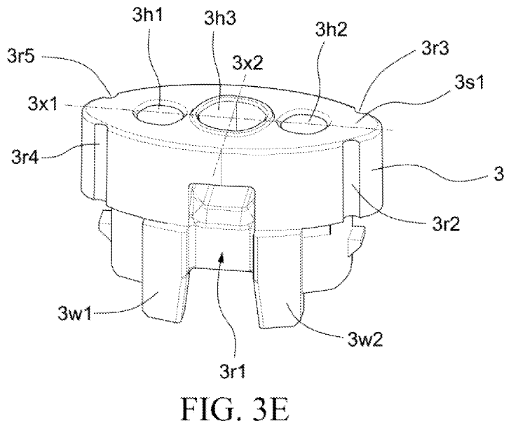

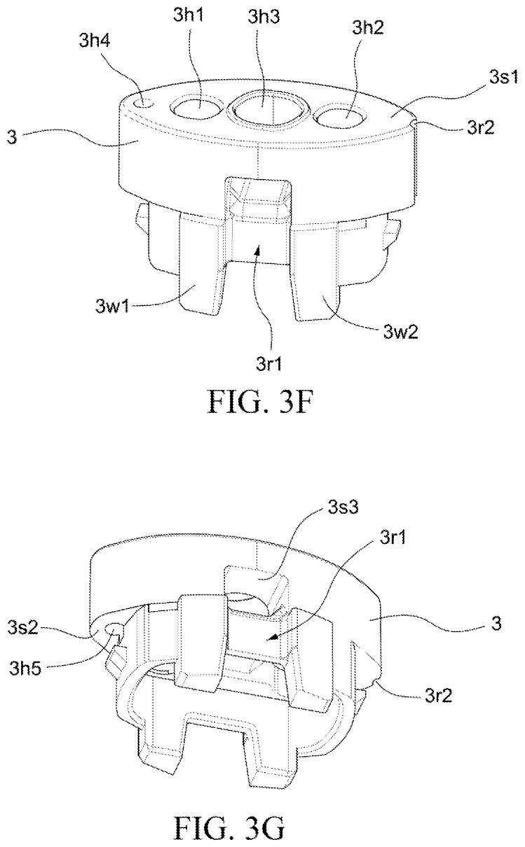

FIG. 3A, FIG. 3B, FIG. 3C, FIG. 3D, FIG. 3E, FIG. 3F and FIG. 3G are three-dimensional views of a heating component cap according to some embodiments of the present disclosure.

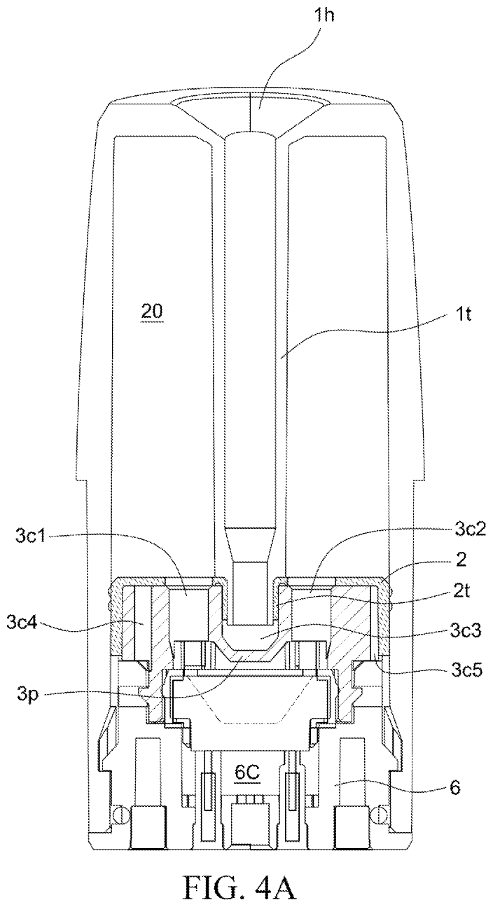

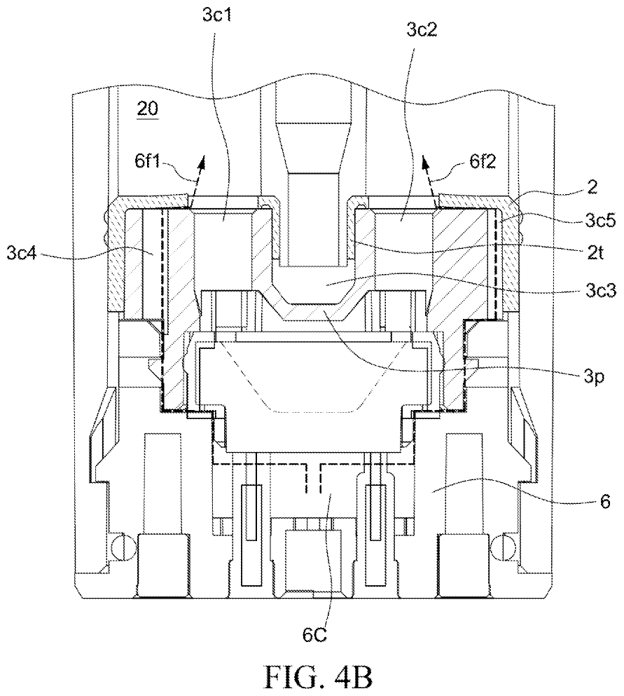

FIG. 3A shows a heating component cap according to an embodiment of the present disclosure. As shown in FIG. 3A, the heating component cap 3 has openings 3h1, 3h2 and 3h3 on a surface 3s1. The opening 3h1 extends into the heating component cap 3 and forms a channel (for example, a channel 3c1 shown in FIG. 4A). The opening 3h2 extends into the heating component cap 3 and forms a channel (for example, a channel 3c2 shown in FIG. 4A). The opening 3h3 extends into the heating component cap 3 and forms a channel (for example, a channel 3c3 shown in FIG. 4A). In some embodiments, the heating component cap 3 may have more channels. In some embodiments, the heating component cap 3 may have fewer channels.

The surface 3s1 has an edge 3e. The surface 3s1 is in a shape similar to an ellipse. The surface 3s1 has a length in a direction in which an axis 3x1 extends. The surface 3s1 has a width in a direction in which an axis 3x2 extends. The axis 3x1 and the axis 3x2 are perpendicular to each other. In some embodiments, the surface 3s1 may be in other shapes.

The heating component cap 3 has pillar portions 3w1 and 3w2. The pillar portions 3w1 and 3w2 define a groove 3r1 therebetween. The groove 3r1 is in fluid communication with the opening 3h3. The groove 3r1 is in fluid communication with the channel 3c3 of the heating component cap 3 (as shown in FIG. 4A). The groove 3r1 is in fluid communication with an atomization chamber 6C (as shown in FIG. 4A). The fluid in the present disclosure includes a liquid or gas.

The heating component cap 3 further includes a groove 3r2. The groove 3r2 extends from the surface 3s1 to a surface 3s2 (as shown in FIG. 3G). The groove 3r2 forms a channel between the heating component cap 3 and the cap sealing member 2 (for example, a channel 3c5 shown in FIG. 4A). In FIG. 3A, the groove 3r2 is located on the right side of the heating component cap 3. The groove 3r2 is located at a junction of the edge 3e and the axis 3x1. The groove 3r2 is in fluid communication with the atomization chamber 6C (as shown in FIG. 4A).

In some embodiments, a groove may be disposed at the left side of the heating component cap 3. In some embodiments, two junctions of the edge 3e and the axis 3x1 may both each have a groove.

In some embodiments, the cross-sectional area of the groove 3r2 may range from 0.05 mm² to 0.3 mm² In some embodiments, the cross-sectional area of the groove 3r2 may range from 0.3 mm² to 0.5 mm² In some embodiments, the cross-sectional area of the groove 3r2 may range from 0.5 mm² to 3.14 mm² In some embodiments, the radius of the groove 3r2 may range from 0.1 mm to 0.3 mm. In some embodiments, the radius of the groove 3r2 may range from 0.3 mm to 0.5 mm. In some embodiments, the radius of the groove 3r2 may range from 0.5 mm to 1 mm.

FIG. 3B shows a heating component cap according to another embodiment of the present disclosure. The heating component cap 3 shown in FIG. 3B has the groove 3r2 and a groove 3r3. The groove 3r2 extends from the surface 3s1 to a surface 3s3 (as shown in FIG. 3G). The groove 3r3 extends from the surface 3s1 to the surface 3s3 (as shown in FIG. 3G). The groove 3r2 is disposed at a junction of the edge 3e and the axis 3x2. The groove 3r3 is disposed at a junction of the edge 3e and the axis 3x2. In some embodiments, only one of the junctions of the edge 3e and the axis 3x2 has a groove. In some embodiments, the groove 3r2 may be removed. In some embodiments, the groove 3r3 may be removed.

The cap sealing member 2 covers the groove 3r2 on the surface 3s1. The cap sealing member 2 covers the groove 3r3 on the surface 3s1. The cap sealing member 2 exposes the groove 3r2 on the surface 3s3. The cap sealing member 2 exposes the groove 3r3 on the surface 3s3.

FIG. 3C shows a heating component cap according to another embodiment of the present disclosure. The heating component cap 3 shown in FIG. 3C has the groove 3r2 and the groove 3r3. The groove 3r2 extends from the surface 3s1 to the surface 3s2 (as shown in FIG. 3G). The groove 3r3 extends from the surface 3s1 to the surface 3s2. The groove 3r2 is adjacent to the junction of the edge 3e and the axis 3x1. The groove 3r3 is adjacent to the junction of the edge 3e and the axis 3x1.

The groove 3r2 is located between the junction of the edge 3e and the axis 3x1 and the junction of the edge 3e and the axis 3x2. The groove 3r3 is located between the junction of the edge 3e and the axis 3x1 and the junction of the edge 3e and the axis 3x2. The groove 3r2 is disposed on one side of the edge 3e relative to the axis 3x1, and the groove 3r3 is disposed on another side of the edge 3e relative to the axis 3x1. The groove 3r2 and the groove 3r3 are disposed on the same side of the edge 3e relative to the axis 3x2.

In some embodiments, the groove 3r2 and the groove 3r3 may be disposed on the same side of the edge 3e relative to the axis 3x1.

FIG. 3D shows a heating component cap according to another embodiment of the present disclosure. The heating component cap 3 shown in FIG. 3D has the groove 3r2 and the groove 3r3. The groove 3r2 extends from the surface 3s1 to the surface 3s2 (as shown in FIG. 3G). The groove 3r3 extends from the surface 3s1 to the surface 3s2 (as shown in FIG. 3G). The groove 3r2 is adjacent to the junction of the edge 3e and the axis 3x1. The groove 3r3 is adjacent to the junction of the edge 3e and the axis 3x1. The groove 3r2 is disposed on one side of the edge 3e relative to the axis 3x1, and the groove 3r3 is disposed on another side of the edge 3e relative the axis 3x1. The groove 3r2 is disposed on one side of the edge 3e relative to the axis 3x2, and the groove 3r3 is disposed on another side of the edge 3e relative to the axis 3x2.

The groove 3r2 and the groove 3r3 are disposed on different sides of the edge 3e relative to the axis 3x1. The groove 3r2 and the groove 3r3 are disposed on different sides of the edge 3e relative to the axis 3x2.

FIG. 3E shows a heating component cap according to another embodiment of the present disclosure.

The heating component cap 3 shown in FIG. 3E has the groove 3r2, the groove 3r3, a groove 3r4 and a groove 3r5. The groove 3r2 extends from the surface 3s1 to the surface 3s2 (as shown in FIG. 3G). The groove 3r3 extends from the surface 3s1 to the surface 3s2. The groove 3r4 extends from the surface 3s1 to the surface 3s2. The groove 3r5 extends from the surface 3s1 to the surface 3s2.

The groove 3r2 and the groove 3r3 are located on the same side of the axis 3x2. The groove 3r4 and the groove 3r5 are located on the same side of the axis 3x2. The groove 3r2 and the groove 3r4 are located on the same side of the axis 3x1. The groove 3r3 and the groove 3r5 are located on the same side of the axis 3x1.

The groove 3r2 and the groove 3r3 are axisymmetric relative to the axis 3x1. The groove 3r4 and the groove 3r5 are axisymmetric relative to the axis 3x1. The groove 3r2 and the groove 3r4 are axisymmetric relative to the axis 3x2. The groove 3r3 and the groove 3r5 are axisymmetric relative to the axis 3x2. In some embodiments, the groove 3r2, the groove 3r3, the groove 3r4 and the groove 3r5 may have the same cross-sectional area. In some embodiments, the groove 3r2, the groove 3r3, the groove 3r4 and the groove 3r5 may have different cross-sectional areas. The groove 3r2, the groove 3r3, the groove 3r4 and the groove 3r5 are in fluid communication with the atomization chamber 6C (as shown in FIG. 4A).

FIG. 3F shows a heating component cap according to another embodiment of the present disclosure.

As shown in FIG. 3F, the heating component cap 3 further has an opening 3h4 on the surface 3s1. The opening 3h4 extends into the heating component cap 3 and forms a channel (for example, a channel 3c4 shown in FIG. 4A). The heating component cap 3 further has the groove 3r2. The groove 3r2 extends from the surface 3s1 to the surface 3s2 (as shown in FIG. 3G). In some embodiments, the opening 3h4 and the groove 3r2 are located on different sides of the axis 3x2. In some embodiments, the opening 3h4 and the groove 3r2 are located on the same side of the axis 3x2.

In some embodiments, the heating component cap 3 may be additionally provided with an opening similar to the opening 3h4. In some embodiments, the heating component cap 3 may be additionally provided with a groove similar to the groove 3r2. In some embodiments, the heating component cap 3 may be additionally provided with a plurality of grooves shown in FIG. 3B, FIG. 3C, FIG. 3D and FIG. 3E.

FIG. 3G is a three-dimensional view of a heating component cap according to some embodiments of the present disclosure.

As shown in FIG. 3G, the heating component cap 3 has an opening 3h5 on the surface 3s2. The opening 3h4 runs through the heating component cap 3 from the surface 3s1 to the opening 3h5 on the surface 3s2 to form the channel 3c4. In some embodiments, the opening 3h4 and the opening 3h5 may be aligned with each other in a vertical direction. In some embodiments, the opening 3h4 and the opening 3h5 may not be aligned with each other in a vertical direction.

FIG. 4A and FIG. 4B are cross-sectional views of a cartridge according to some embodiments of the present disclosure.

The cross-sectional view shown in FIG. 4A may correspond to the heating component cap 3 shown in FIG. 3F.

As shown in FIG. 4A, the housing 1 has an opening 1h and a tube 1t extending from the opening 1h toward the cap sealing member 2. The tube 1t, the cap sealing member 2, and the housing 1 define a liquid storage compartment 20. The vaporizable material may be stored in the liquid storage compartment 20.

The tube 1t may have a portion extending into the channel 3c3. The tube 1t may have an uneven outer diameter. As shown in FIG. 4A, the portion of the tube 1t extending into the channel 3c3 has a relatively small outer diameter. The tube 1t may have an uneven inner diameter. As shown in FIG. 4A, the portion of the tube 1t extending into the channel 3c3 has a relatively small inner diameter.

The tube 1t is coupled to the channel 3c3 through the opening 3h3 of the cap heating component 3. The tube 1t is in fluid communication with the channel 3c3 through the opening 3h3 of the cap heating component 3. The channel 3c3 is isolated from the liquid storage compartment 20 through the tube 1t.

As shown in FIG. 4A, the cap sealing member 2 may expose the openings 3h1, 3h2 and 3h3 of the heating component cap 3. The cap sealing member 2 does not cover the openings 3h1, 3h2 and 3h3 of the heating component cap 3. The cap sealing member 2 does not block the channels 3c1, 3c2 and 3c3.

The channel 3c1 is in fluid communication with the groove 5c of the heating component 5. The channel 3c2 is in fluid communication with the groove 5c of the heating component 5. The e-liquid stored in the liquid storage compartment 20 may flow into the groove 5c through the channel 3c1. The e-liquid stored in the liquid storage compartment 20 may flow into the groove 5c through the channel 3c2. The groove 5c of the heating component 5 is in fluid communication with the liquid storage compartment 20. The e-liquid may be in full contact with the heating component 5 in the groove 5c. The heating circuit on the surface of or inside the heating component 5 may heat the e-liquid to generate an aerosol.

The heating component base 6 and the heating component 5 define the atomization chamber 6C therebetween. The heating component 5 is partially exposed in the atomization chamber 6C. The aerosol generated by the heating component 5 through heating is formed in the atomization chamber 6C. The aerosol generated by the heating component 5 through heating flows through the tube 1t and the opening 1h and is then inhaled by the user. The tube 1t is in fluid communication with the atomization chamber 6C. The groove 30 is in fluid communication with the atomization chamber 6C.

The cap sealing member 2 may cover the opening 3h4 of the heating component cap 3. The cap sealing member 2 may block one end of the channel 3c4. The cap sealing member 2 covers the groove 3r2 on the surface 3s1. The cap sealing member 2 exposes the groove 3r2 on the surface 3s2. The cap sealing member 2 may block one end of the channel 3c5. The channel 3c4 is in fluid communication with the atomization chamber 6C. The groove 3r2 is in fluid communication with the atomization chamber 6C. The channel 3c5 is in fluid communication with the atomization chamber 6C.

As shown in FIG. 4A, the heating component cap 3 has a blocking element 3p. The blocking element 3p isolates the tube 1t from the groove 5c of the heating component 5. The blocking element 3p isolates the channel 3c3 from the groove 5c of the heating component 5.

During the process of using the vaporization device, when the residual condensate in the tube 1t reaches a particular volume, the condensate may fall from the tube 1t. The blocking element 3p can prevent the condensate falling from the tube 1t from coming into contact with the heating component 5. The blocking element 3p can prevent the fallen condensate from contaminating the heating component 5. The blocking element 3p can prevent the fallen condensate from changing the flavor of the aerosol. The blocking element 3p can prevent the condensate from falling onto the heating component with high temperature to cause splashing of the liquid. The blocking element 3p can prevent the splashed liquid from burning the user.

The existing electronic cigarette products fail to take the pressure balance of the e-liquid storage chamber into consideration. In the existing electronic cigarette products, the e-liquid storage chamber is generally designed to be completely sealed to prevent spilling of the vaporizable solution. As the user continuously uses the electronic cigarette product, the amount of the vaporizable solution in the e-liquid storage chamber continuously decreases, so that the pressure in the e-liquid storage chamber decreases to form a negative pressure. The negative pressure makes it difficult for the vaporizable solution in the e-liquid storage chamber to evenly flow to the heating component, and the heating component cannot evenly absorb the vaporizable solution. In this case, when the temperature of the heating component rises, there will be a high probability that no vaporizable solution exists on portion of the heating component during heating and a burning smell may be generated, resulting in poor user experience.

FIG. 4B shows an airflow 6f1 and an airflow 6f2 from the atomization chamber 6C to the liquid storage compartment 20.

When the atomizing device is placed still and not used by the user, the opening 3h4 is tightly combined with the cap sealing member 2, and the e-liquid in the liquid storage compartment 20 does not leak out from the channel 3c4. When the vaporization device is placed still and not used by the user, the top of the channel 3c5 is tightly combined with the cap sealing member 2, and the e-liquid in the liquid storage compartment 20 does not leak out from the channel 3c5.

As the user continuously uses the vaporization device, the amount of the vaporizable solution in the liquid storage compartment 20 continuously decreases, so that the pressure in the liquid storage compartment 20 gradually decreases. The decrease in the pressure in the liquid storage compartment 20 may lead to the formation of a negative pressure. The decrease in the pressure in the liquid storage compartment 20 makes it difficult for the vaporizable solution to flow to the groove 5c of the heating component 5 through the channels 3c1 and 3c2. When the groove 5c does not completely absorb the vaporizable solution, no vaporizable solution exists on portion of the heating component during heating and a burning smell may be generated.

The foregoing problem can be resolved by the configuration of the channel 3c4 in the heating component cap 3. The foregoing problem can be resolved by the configuration of the channel 3c5 in the heating component cap 3. The configuration of the channel 3c4 in the heating component cap 3 can balance the pressure in the liquid storage compartment 20. The configuration of the channel 3c5 in the heating component cap 3 can balance the pressure in the liquid storage compartment 20. In some embodiments, the heating component cap 3 only has one of the channel 3c4 or the channel 3c5. In some embodiments, the heating component cap 3 may have both the channel 3c4 and the channel 3c5.

Because the atomization chamber 6C is in fluid communication with the tube 1t, the pressure in the atomization chamber 6C is approximately equal to one atmospheric pressure. As the vaporizable solution in the liquid storage compartment 20 continuously decreases, the pressure in the liquid storage compartment 20 gradually decreases to less than one atmospheric pressure.

The pressure difference between the atomization chamber 6C and the liquid storage compartment 20 causes the airflow 6f1 from the atomization chamber 6C to reach a junction of the opening 3h4 and the cap sealing member 2 through the channel 3c4. The airflow 6f1 may partially push open the cap sealing member 2. The airflow 6f1 may partially deform the cap sealing member 2. The airflow 6f1 may enter the liquid storage compartment 20 through a gap generated by the deformation of the cap sealing member 2.

The pressure difference between the atomization chamber 6C and the liquid storage compartment 20 causes the airflow 6f2 from the atomization chamber 6C to reach a junction of the groove 3r2 and the cap sealing member 2 through the channel 3c5. The airflow 6f2 may partially push open the cap sealing member 2. The airflow 6f2 may partially deform the cap sealing member 2. The airflow 6f2 may enter the liquid storage compartment 20 through a gap generated by the deformation of the cap sealing member 2.

The airflow 6f1 entering the liquid storage compartment 20 can increase the pressure in the liquid storage compartment 20. The airflow 6f1 entering the liquid storage compartment 20 can balance the pressure between the liquid storage compartment 20 and the atomization chamber 6C. The airflow 6f2 entering the liquid storage compartment 20 can increase the pressure in the liquid storage compartment 20. The airflow 6f2 entering the liquid storage compartment 20 can balance the pressure between the liquid storage compartment 20 and the atomization chamber 6C.

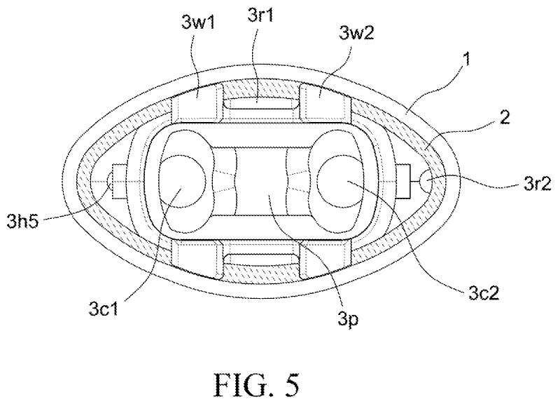

FIG. 5 is a bottom view of portion of a cartridge according to some embodiments of the present disclosure.

FIG. 5 is a bottom view of the housing 1, the cap sealing member 2 and the heating component cap 3 which are combined with each other. The cap sealing member 2 is disposed between the housing 1 and the heating component cap 3.

The groove 3r1 is formed between pillar portions 3w1 and 3w2. The groove 3r1 is formed between the heating component cap 3 and the housing 1. The groove 3r1 creates a space between the heating component cap 3 and the housing 1. The groove 3r1 enables the channel 3c3 of the heating component cap 3 to be in fluid communication with the atomization chamber 6C. The blocking element 3p is disposed between the channels 3c2 and 3c3. The blocking element 3p may prevent the condensate falling from the tube 1t from coming into contact with the heating component 5.

As used herein, spatially relative terms such as “under”, “below”, “lower portion”, “above”, “upper portion”, “lower portion”, “left side”, “right side”, and the like may be used herein to simply describe a relationship between one element or feature and another element or feature as shown in the figures. In addition to orientation shown in the figures, spatially relative terms are intended to encompass different orientations of the device in use or operation. An apparatus may be oriented in other ways (rotated 90 degrees or at other orientations), and the spatially relative descriptors used herein may also be used for explanation accordingly. It should be understood that when a component is “connected” or “coupled” to another component, the component may be directly connected to coupled to another component, or an intermediate component may exist.

As used herein, the terms “approximately”, “basically”, “substantially”, and “about” are used to describe and explain small variations. When used in combination with an event or a situation, the terms may refer to an example in which an event or a situation occurs accurately and an example in which the event or situation occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all ranges disclosed herein include endpoints. The term “substantially coplanar” may refer to two surfaces within a few micrometers (m) positioned along the same plane, for example, within 10 μm, within 5 μm, within 1 μm, or within 0.5 μm located along the same plane. When reference is made to “substantially” the same numerical value or characteristic, the term may refer to a value within ±10%, ±5%, ±1%, or ±0.5% of the average of the values.

As used herein, the terms “approximately”, “basically”, “substantially”, and “about” are used to describe and explain small variations. When used in combination with an event or a situation, the terms may refer to an example in which an event or a situation occurs accurately and an example in which the event or situation occurs approximately. For example, when being used in combination with a value, the term may refer to a variation range of less than or equal to ±10% of the value, for example, less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, if a difference between two values is less than or equal to ±10% of an average value of the value (for example, less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%), it could be considered that the two values are “substantially” the same. For example, being “substantially” parallel may refer to an angular variation range of less than or equal to ±10° with respect to 0°, for example, less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°. For example, being “substantially” perpendicular may refer to an angular variation range of less than or equal to ±10° with respect to 90°, for example, less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

For example, two surfaces can be deemed to be coplanar or substantially coplanar if a displacement between the two surfaces is no greater than 5 μm, no greater than 2 μm, no greater than 1 μm, or no greater than 0.5 μm. A surface can be deemed to be planar or substantially planar if a difference between any two points on the surface is no greater than 5 μm, no greater than 2 μm, no greater than 1 μm, or no greater than 0.5 μm.

As used herein, the terms “conductive,” “electrically conductive” and “electrical conductivity” refer to an ability to transport an electric current. Electrically conductive materials typically indicate those materials that exhibit little or no opposition to the flow of an electric current. One measure of electrical conductivity is Siemens per meter (S/m). Typically, an electrically conductive material is one having a conductivity greater than approximately 10⁴ S/m, such as at least 10⁵ S/m or at least 10⁶ S/m. The electrical conductivity of a material can sometimes vary with temperature. Unless otherwise specified, the electrical conductivity of a material is measured at room temperature.

As used herein, the singular terms “a,” “an,” and “the” may include plural referents unless the context clearly dictates otherwise. In the description of some embodiments, assemblies provided “on” or “above” another assembly may encompass a case in which a former assembly is directly on a latter assembly (for example, in physical contact with the latter assembly), and a case in which one or more intermediate assemblies are located between the former assembly and the latter assembly.

Unless otherwise specified, space descriptions such as “above”, “below”, “up”, “left”, “right”, “down”, “top portion”, “bottom portion”, “vertical”, “horizontal”, “side face”, “higher than”, “lower than”, “upper portion”, “on”, “under”, “downward”, etc. are indicated relative to the orientation shown in the figures. It should be understood that the space descriptions used herein are merely for illustrative purposes, and actual implementations of the structures described herein may be spatially arranged in any orientation or manner, provided that the advantages of embodiments of the present invention are not deviated due to such arrangement.

While the present invention has been described and illustrated with reference to specific embodiments thereof, these descriptions and illustrations do not limit the present invention. It should be understood by those skilled in the art that various changes may be made and equivalents may be substituted without departing from the true spirit and scope of the present invention as defined by the appended claims. The illustrations may not be necessarily drawn to scale. There may be distinctions between the artistic renditions in the present invention and the actual apparatus due to manufacturing processes and tolerances. There may be other embodiments of the present invention which are not specifically illustrated. The specification and drawings are to be regarded as illustrative rather than restrictive. Modifications may be made to adapt a particular situation, material, composition of matter, method, or process to the objective, spirit and scope of the present invention. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present invention. Therefore, unless otherwise specifically indicated herein, the order and grouping of operations shall not be construed as any limitation on the present application.

Several embodiments of the present invention and features of details are briefly described above. The embodiments described in the present invention may be easily used as a basis for designing or modifying other processes and structures for realizing the same or similar objectives and/or obtaining the same or similar advantages introduced in the embodiments of the present invention. Such equivalent construction does not depart from the spirit and scope of the present invention, and various variations, replacements, and modifications can be made without departing from the spirit and scope of the present invention.

What is claimed is:

1. A vaporization device, comprising:
a housing, a heating component cap having a first surface and a second surface, and a first sealing member disposed on the heating component cap, wherein
the first surface has an edge, a length extending along a first axis, and a width extending along a second axis;
the heating component cap comprises a first groove, and the first groove and the first sealing member define a first channel;
the first sealing member covers the first groove on the first surface, and exposes the first groove on the second surface.

2. The vaporization device according to claim 1, wherein the heating component cap comprises a second groove, the second groove and the first sealing member define a second channel, the first sealing member covers the second groove on the first surface, and the first sealing member exposes the second groove on the second surface.

3. The vaporization device according to claim 1, wherein the first groove is located between a junction of the edge and the first axis and a junction of the edge and the second axis.

4. The vaporization device according to claim 1, wherein the first groove is disposed at a junction of the edge and the first axis.

5. The vaporization device according to claim 2, wherein the first groove and the second groove are disposed on the same side of the second axis, and the first groove and the second groove are disposed on different sides of the first axis.

6. The vaporization device according to claim 2, wherein the first groove and the second groove are disposed on the same side of the first axis, and the first groove and the second groove are disposed on different sides of the second axis.

7. The vaporization device according to claim 2, wherein the first groove is disposed at a first junction of the edge and the second axis, and the second groove is disposed at a second junction of the edge and the second axis.

8. The vaporization device according to claim 2, wherein the first groove and the second groove are disposed on different sides of the first axis, and the first groove and the second groove are disposed on different sides of the second axis.

9. The vaporization device according to claim 1, further comprising a heating component base removably combined with the heating component cap, and a heating component disposed between the heating component cap and the heating component base, wherein the heating component and the heating component base define an atomization chamber, and the first channel is in fluid communication with the atomization chamber.

10. The vaporization device according to claim 1, wherein the heating component cap comprises a first opening on the first surface, a second opening on the second surface, and a second channel running through the first opening and the second opening, wherein the first sealing member covers the first opening and exposes the second opening.

11. A vaporization device, comprising:
a housing, a heating component cap, a heating component base, a first sealing member disposed on the heating component cap, and a heating component disposed between the heating component cap and the heating component base, wherein
the heating component and the heating component base define an atomization chamber; and
the heating component cap comprises a first opening on a first surface and a first groove at an edge, and the first sealing member covers the first opening and exposes the first opening.

12. The vaporization device according to claim 11, wherein the first groove and the first sealing member define a first channel, and the first channel is in fluid communication with the atomization chamber.

13. The vaporization device according to claim 11, wherein the heating component cap further comprises a second groove, a third groove, and a fourth groove at an edge, and the first sealing member covers the second groove, the third groove and the fourth groove on the first surface of the heating component cap.

14. The vaporization device according to claim 13, wherein the first sealing member exposes the first groove, the second groove, the third groove and the fourth groove on the second surface of the heating component cap.

15. The vaporization device according to claim 13, wherein the first groove, the second groove, the third groove and the fourth groove are in fluid communication with the atomization chamber.

16. The vaporization device according to claim 11, wherein the housing and the first sealing member define a liquid storage compartment, the first opening extends into the heating component cap to form a second channel, and the heating component is in fluid communication with the liquid storage compartment through the second channel.

17. The vaporization device according to claim 11, wherein the heating component cap further comprises a third channel, the third channel forms a second opening on the first surface of the heating component cap, the first sealing member exposes the second opening, and the third channel is in fluid communication with the atomization chamber.

18. The vaporization device according to claim 11, wherein the heating component cap further comprises a third channel and the heating component comprises a groove, wherein the third channel is isolated from the groove.

19. The vaporization device according to claim 18, wherein the housing and the first sealing member define a liquid storage compartment, the housing comprises a first tube extending into the liquid storage compartment, the first tube is coupled to the third channel, and the third channel is isolated from the liquid storage compartment through the first tube.

20. The vaporization device according to claim 11, wherein the heating component cap further comprises a third opening on the first surface and a fourth channel extending from the third opening into the heating component cap, the first sealing member covers the third opening, and the fourth channel is in fluid communication with the atomization chamber.
